(19) United States
(12) Patent Application Publication
(10) Pub. No.: US 2010/0132859 A1
(43) Pub. Date: Jun. 3, 2010

(54) TIRE WITH ELECTRICALLY NON-CONDUCTIVE TREAD WHICH CONTAINS ELECTRICALLY CONDUCTIVE RUBBER STRIP

(76) Inventors: Pascal Patrick Steiner, Diekirch (LU); Marc Weybert, Strassen (LU); Peter Phelps Roch, Luxembourg (LU); Alain Joseph Jose Godefroid, Meix-Ie-Tige (BE); Jean-Nicolas Helt, Mont-Saint-Martin (FR)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/326,261

(22) Filed: Dec. 2, 2008

(51) Int. Cl. B60C 19/08

(52) U.S. Cl. 152/152.1

(57) ABSTRACT

The invention relates to a tire having tread of a cap/base configuration. The tread contains a thin electrically conductive rubber strip in the form of an extension of said tread base rubber layer which extends radially outward from the tread base rubber layer through an electrically resistive tread cap rubber layer to and including its running surface circumferentially around the tread to thereby provide a path of electrical conductivity through the tread cap layer to its running surface. The composite of the electrically non-conductive tread cap rubber layer and electrically conductive strip at the running surface of the tire tread have a similar abradability.

### FIELD OF THE INVENTION

This invention relates to a tire having tread of a cap/base configuration. The tread contains a thin electrically conductive rubber strip in the form of an extension of said tread base rubber layer which extends radially outward from the tread base rubber layer through an electrically resistive tread cap rubber layer to and including its running surface circumferentially around the tread to thereby provide a path of electrical conductivity through the tread cap layer to its running surface. The composite of the electrically non-conductive tread cap rubber layer and electrically conductive strip at the running surface of the tire tread has a uniform abradability.

### BACKGROUND FOR THE INVENTION

Vehicular tires are often of a cap/base construction and are sometimes provided with a tread which is electrically resistive. For such tires, an underlying electrically conductive tread base may be provided from which a thin electrically conductive rubber strip extends from the tread base rubber layer through the electrically resistive tread cap rubber layer to its running surface. In this manner, a path of electrical conductivity is provided which extends through the electrically resistive tread cap layer to its running surface.

It can readily be envisioned that, as the electrically resistive outer tread cap rubber layer with its running surface wears away by normal use of the tire, the strip of electrically conductive rubber may wear at a rate significantly different from the rate of wear of the tread cap rubber layer. A challenge may thereby be presented of maintaining the path of electrical conductivity through the tread cap rubber layer.

For this invention, the composite of electrically conductive rubber strip and tread cap rubber layer at the running surface of the tread provides a substantially uniform abradability at the running surface of the tire tread which is believed to be a significant departure from past practice.

In the description of this invention, the terms “rubber” and “elastomer” if used herein, are used interchangeably, unless otherwise indicated. The terms “rubber composition”, “compounded rubber” and “rubber compound”, if used herein, are used interchangeably to refer to “rubber which has been blended or mixed with various ingredients and materials” and such terms are well known to those having skill in the rubber mixing or rubber compounding art. The terms “cure” and “vulcanize” may be used interchangeably unless otherwise indicated.

In the description of this invention, the term “phr” refers to parts of a respective material per 100 parts by weight of rubber, or elastomer.

### SUMMARY AND PRACTICE OF THE INVENTION

In accordance with this invention, a tire is provided having a tread of a cap/base construction comprised of:

(A) an electrically resistive tread cap rubber layer (relative to an underlying tread base rubber layer) having an outer running surface (running surface intended to be ground-contacting),

(B) an electrically conductive rubber tread base layer (relative to said tread cap rubber layer) underlying said tread cap layer, and

(C) a thin, relatively electrically conductive (relative to said tread cap rubber layer), rubber strip as a part of the tread base rubber layer which extends radially outward from said tread base layer through said electrically resistive tread cap layer to and including its outer running surface circumferentially around the tread to thereby provide a path of electrical conductivity through the tread cap layer to its running surface;

wherein said thin rubber strip extension is unitary with and of the same rubber composition as said tread base rubber layer and is thereby a unitary extension of said tread base rubber layer;

characterized in that composite of electrically conductive rubber strip and tread cap rubber layer at the running surface of the tread has a substantially uniform abradability.

In one embodiment of this invention said tread cap rubber composition contains from about 40 to about 70 phr of silica and carbon black reinforcing filler comprised of:

(A) about 20 to about 60 phr of synthetic amorphous precipitated silica (precipitated silica), and

(B) from zero to about 30, alternately from about 5 to about 30, phr of rubber reinforcing carbon black.

In one embodiment of this invention said tread base rubber composition and its thin rubber strip extension, contains from about 40 to about 70 phr of silica and carbon black reinforcing filler comprised of:

(A) from up to about 30 phr of synthetic amorphous precipitated silica (precipitated silica), and

(B) about 40 to about 60 phr of rubber reinforcing carbon black.

Representative examples of various rubber reinforcing carbon blacks may be found, for example, in The Vanderbilt Rubber Handbook (1978), Pages 408 through 428, and particularly Page 417 of which their properties are reported in terms of Iodine value, g/kg, (ASTM D1510) and dibutylphthalate (DBP) value, cc/100 g, (ASTM D2414).

Representative examples of such reported rubber reinforcing carbon blacks are, for example, N110, N121, N234, and N347 which are ASTM designations.

In practice, said tread cap layer rubber composition preferably contains less than 30, alternately less than 25, phr of carbon black reinforcement and said tread base rubber composition and said thin strip rubber composition contains at least 40, alternately at least 45, phr of carbon black reinforcement and preferably at least 10 phr more carbon black reinforcement than said tire cap layer rubber composition.

In practice, said tread cap rubber composition preferably contains amorphous synthetic silica based reinforcement as precipitated silica.

In one aspect of the invention, said tread cap, tread base and thin rubber strip may be co-extruded together to form an integral tire tread construction so that, therefore, an integral tire tread construction is comprised of a co-extruded tread cap, tread base and said thin rubber strip extending from, and a part of, said tread base through said tread cap to the running surface of said tread cap rubber layer.

In one aspect of the invention, one end of said thin rubber strip extending from said tread base rubber layer through said tread cap rubber layer terminates at, and thereby includes a portion of, said running surface of said tread cap.

In practice, it is desired that the thickness of said thin rubber strip is in a range of about 0.5 to about 10, alternately from about 0.5 to about 3, millimeters (mm).

In practice, the electrical conductivities of the tread cap rubber layer and underlying integral and co-extruded tread base layer rubber are largely dependent upon their individual carbon black contents. For example, a rubber composition which contains only 10 phr, and generally less than about 30 phr of rubber reinforcing carbon black is conventionally significantly more electrically resistive (significantly less electrically conductive) than a rubber composition which contains at least 35 phr of rubber reinforcing carbon black. Such phenomenon is understood to be well known to those having skill in such art.

In the practice of this invention, said tread cap rubber composition which contains silica reinforcement (e.g. precipitated silica) may preferably contain a coupling agent as having a moiety reactive with hydroxyl groups (e.g. silanol groups) contained on the surface of the silica (precipitated silica) and another different moiety interactive with the diene-based elastomer(s).

The forming of the tire tread is contemplated to be by conventional means such as, for example, by extrusion of rubber composition to provide a shaped, unvulcanized rubber tire tread. Such forming of a tire tread is well known to those having skill in such art.

It is understood that the tire, as a manufactured article, is prepared by shaping and sulfur curing the assembly of its components at an elevated temperature (e.g. 140° C. to 180° C.) and elevated pressure in a suitable mold. Such practice is well known to those having skill in such art.

The diene-based elastomers for the tire tread rubber composition of this invention, are, for example, homopolymers and copolymers of at least one conjugated diene such as, for example, isoprene and/or 1,3-butadiene and copolymers of at least one conjugated diene, such as for example, isoprene and/or 1,3-butadiene, and a vinyl aromatic compound such as styrene or alphamethyl styrene, preferably styrene.

Representative of such diene-based elastomers are, for example, elastomers comprised of cis 1,4-polyisoprene (natural and synthetic), cis 1,4-polybutadiene, high vinyl polybutadiene having a vinyl 1,2-content in a range of about 35 to about 90 percent, isoprene/butadiene copolymer elastomers, styrene/butadiene copolymer elastomers (organic solvent solution polymerization formed or prepared and aqueous emulsion polymerization formed or prepared), styrene/isoprene copolymer elastomers, and styrene/isoprene/butadiene terpolymer elastomers.

It is readily understood by those having skill in the art that the rubber composition would be compounded by methods generally known in the rubber compounding art.

### BRIEF DESCRIPTION OF THE ACCOMPANYING DRAWING

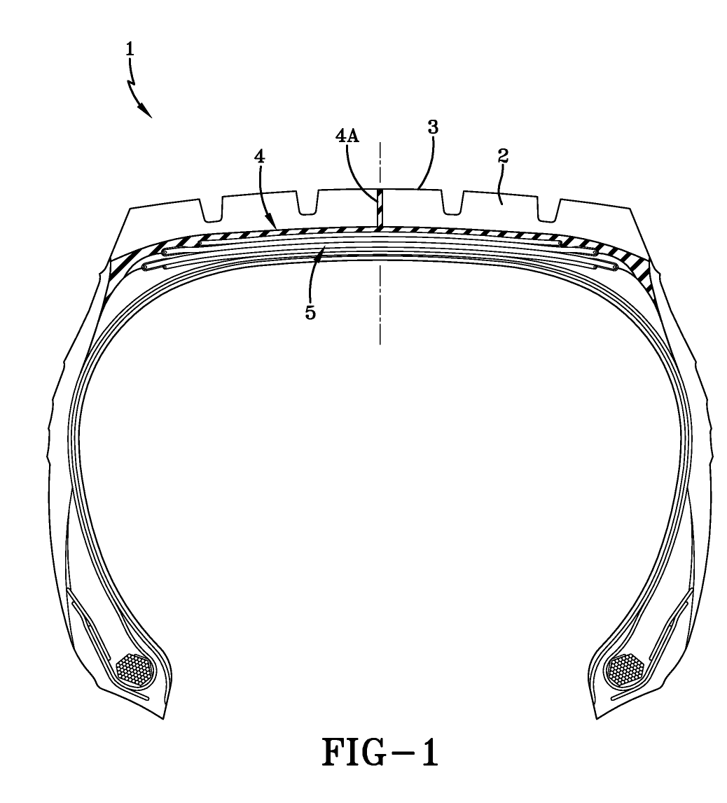

A Drawing (FIG. 1) is provided to further illustrate the invention. For FIG. 1 a cross section of a tire is provided which illustrates a tread composed of an electrically resistive outer tread rubber cap layer with the tread's running surface and an underlying electrically conductive tread base rubber layer which contains an extension in a form of a thin electrically conductive rubber strip which extends radially outward from the tread base rubber layer through the tread cap rubber layer to and including a portion of the tread running surface. The rubber strip thereby provides a path of electrical conductivity from the tread base rubber layer through the electrically resistive tread cap rubber layer to and including a portion of the tread's running surface.

### THE DRAWING

In FIG. 1 a cross section of a tire (1) is depicted with a tread (2) of a cap/base construction composed of an outer electrically resistive tread cap rubber layer (3) and an underlying electrically conductive tread base rubber layer (4) which contains an extension in a form of a thin rubber strip (4A) which extends radially outward from the tread base rubber layer (4) through the tread cap rubber layer (3) to the running surface (5), and extends circumferentially around the periphery of the tread cap rubber layer (3) of the tread (2).

The thin rubber strip (4A) is therefore unitary with and is of the same rubber composition of the tread base rubber layer (4) and thereby provides a path of electrical conductivity from the tread base rubber layer (4) to the tread running surface (5).

In one embodiment of the invention, the composite of said tread cap rubber layer (3) and said thin rubber strip (4A) at the tread running surface (5) has substantially uniform abradability.

The following Example is present to further illustrate the invention. The parts and percentages are by weight unless otherwise indicated.

### EXAMPLE I

Rubber samples are shown to illustrate rubber compositions for a tire tread of a cap/base construction composed of an outer tread cap rubber layer with a tread running surface and an underlying tread base rubber layer with extension in a form of a thin rubber strip which extends through the tread cap rubber layer to and including a portion of its running surface in the sense of the FIG. 1 drawing.

Rubber Sample A is presented to illustrate a rubber composition for said tread cap rubber layer.

Rubber Sample B is presented to illustrate a rubber composition for said tread base rubber layer which therefore includes its thin rubber strip extension.

Table 1 illustrates the rubber compositions for Samples A and B.

TABLE 1

| | | Tread Base and |
|---|---|---|
| | Tread Cap | Conductive Strip |
| | A | B |
| First Non-Productive Mixing Step | | |
| (Mixed to about 160° C.) | | |
| Natural cis 1,4-polyisoprene rubber1 | 80 | 80 |
| Cis 1,4-polybutadiene rubber² | 20 | 20 |
| Carbon black, N121³ | 25 | 0 |
| Carbon black, N347⁴ | 0 | 50 |
| Precipitated silica⁵ | 25 | 0 |
| Silica coupling agent⁶ | 3 | 0 |
| Rubber processing oil | 0 | 2 |
| Fatty acid⁷ | 3 | 3 |
| Zinc oxide | 3 | 3 |
| Productive Mixing Step | | |
| (Mixed to about 115° C.) | | |
| Sulfur | 1.5 | 1.5 |
| Accelerator(s)⁸ | 1.6 | 1.5 |

¹Natural cis 1,4-polyisorene rubber having a cis 1,4-content of at least 96 percent and a Tg of about −65° C.
²As Budene 1207 ™ from The Goodyear Tire & Rubber Company having a cis 1,4 content of at least 96 percent and a Tg of about −100° C.
³N121, a rubber reinforcing carbon black, ASTM designation
⁴N347, a rubber reinforcing carbon black, ASTM designation
⁵Precipitated silica as Zeosil 1165MP ™ from the Rhodia Company
⁶Composite from Degussa-Hulls comprised of a coupling agent as Si69 ™, a bis-3(triethoxysilylpropyl) polysulfide containing an average of from about 3.4 to about 3.8 connecting sulfur atoms in its polysulfidic bridge, which may sometimes be referred to as a tetrasulfide, on a carbon black carrier in a 50/50 weight ratio and reported in the Table as the composite
⁷Primarily stearic acid (at least 90 percent by weight stearic acid) which also contains oleic and linoleic acids
⁸Sulfenamide based sulfur cure accelerator

The following Table 2 illustrates cure behavior and various physical properties of rubber composition Sample A and Sample B.

TABLE 2

Samples

| Properties | Tread Cap A | Tread Base B |
|---|---|---|
| Stress-strain | | |
| Tensile strength (MPa) | greater than 22 | greater than 22 |
| Elongation at break (%) | 480 | 500 |
| 300% modulus (MPa) | 14.5 | 13 |
| Shore A Hardness | | |
| 100° C. | 66 | 63 |
| Rebound, Hot | | |
| 100° C. | 75 | 71 |

A composite of rubber Samples A and B is prepared which has a exposed surface composed of a circular rubber composition of electrically conductive rubber Sample B surrounded on its sides by electrically resistive rubber Sample A.

The composite is submitted to an abrasion test (DIN D53516) and it was observed that the abradability of the surface of the composite was substantially the same across the surface of the composite (substantially uniform abradability).

It is therefore concluded that for a tire of a configuration similar to FIG. 1, the composite of tread base extension (rubber Sample B) and the tread cap rubber layer (rubber Sample A) at the running surface of the tire tread presents the tread running surface with substantially the same abradability across the running surface of the tire tread (a substantially uniform abradability).

While certain representative embodiments and details have been shown for the purpose of illustrating the invention, it will be apparent to those skilled in this art that various changes and modifications may be made therein without departing from the spirit or scope of the invention.

What is claimed is:

1. A tire having a tread of a cap/base construction comprised of:
(A) a electrically resistive rubber tread cap layer having an outer running surface,
(B) an electrically conductive rubber tread base layer underlying said tread cap layer, and
(C) a thin, relatively electrically conductive (relative to said tread cap rubber layer), rubber strip as a part of the tread base rubber layer which extends radially outward from said tread base layer through said tread cap layer to and including said outer running surface of said tread cap layer,
wherein said thin rubber strip extension is unitary with and of the same rubber composition as said tread base rubber layer and is thereby a unitary extension of said tread base rubber layer;
characterized in that composite of electrically conductive rubber strip and tread cap rubber layer at the running surface of the tread has a substantially uniform abradability.

2. The tire of claim 1 wherein said tread base rubber composition and its thin rubber strip extension, contains from about 40 to about 110 phr of silica and carbon black reinforcing filler comprised of:
(A) from zero to about 30 phr of precipitated silica, and
(B) about 40 to about 80 phr of rubber reinforcing carbon black.

3. The tire of claim 1 wherein said tread cap rubber composition contains from about 40 to about 110 phr of silica and carbon black reinforcing filler comprised of:
(A) about 35 to about 90 phr of precipitated silica, and
(B) about 5 to about 25 phr of rubber reinforcing carbon black.

4. The tire of claim 2 wherein said tread cap rubber composition contains from about 40 to about 110 phr of silica and carbon black reinforcing filler comprised of:
(A) about 35 to about 90 phr of precipitated silica, and
(B) about 5 to about 25 phr of rubber reinforcing carbon black.

5. The tire of claim 1 wherein said tread cap layer rubber composition contains less than 25 phr of carbon black reinforcement and said tread base rubber composition and said thin strip rubber composition contains at least 45 phr of carbon black reinforcement.

6. The tire of claim 1 wherein the thickness of said thin rubber strip is in a range of about 0.5 to about 10 millimeters and wherein, at the running surface of the tire, said thin rubber strip extends circumferentially around the periphery of the tread cap rubber layer.

7. The tire of claim 4 wherein the thickness of said thin rubber strip is in a range of about 0.5 to about 10 millimeters and wherein, at the running surface of the tire, said thin rubber strip extends circumferentially around the periphery of the tread cap rubber layer.
